(19) United States
(12) Patent Application Publication
(10) Pub. No.: US 2008/0007976 A1
(43) Pub. Date: Jan. 10, 2008

(54) POWER SUPPLY DEVICE AND ELECTRIC APPLIANCE PROVIDED THEREWITH

(75) Inventor: Jun Mizuno, Kyoto (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/762,318

(22) Filed: Jun. 13, 2007

(30) Foreign Application Priority Data
Jun. 16, 2006 (JP) 2006-166901

(51) Int. Cl. H02M 3/335

(52) U.S. Cl. 363/21.02

(57) ABSTRACT

A power supply device has a transformer 1; Tr2 that is serially connected to a winding Np; a first circuit 3 that turns on Tr2 by using Vi and Vd; Tr4 that turns on so as to turn off Tr2; a second circuit 5 that turns on/off Tr4 by using Vd; an output smoother circuit 6 that produces Vo by smoothing Vs; an output detector circuit 7 that detects whether or not Vo has reached a threshold; and a third circuit 8 that, when Vo has reached the threshold during the off period of Tr4, advances the timing with which Tr4 turns on by using Vd, and that, when Vo has reached the threshold during the on period of Tr4, delays the timing with which Tr4 turns off until a period during which Tr4 is forcibly kept on has elapsed, or, before this, until Vo has dropped below the threshold. With this configuration, it is possible to achieve an improvement in efficiency in light load conditions without increasing an output ripple voltage.

This application is based on Japanese Patent Application No. 2006-166901 filed on Jun. 16, 2006, the contents of which are hereby incorporated by reference.

### BACKGROUND OF THE INVENTION

1. Field of the Invention

The present invention relates to power supply devices that produce a desired output voltage from an input voltage, and to electric appliances provided therewith. More particularly, the present invention relates to an RCC (ringing choke converter)-type self-excited switching power supply device.

2. Description of Related Art

FIG. 6 is a block diagram showing an example of a conventional self-excited switching power supply device.

As shown in this figure, conventionally, an RCC-type (a flyback-type) self-excited switching power supply device includes a transformer 101, an oscillating transistor 102, an oscillation control circuit 103, an output smoother circuit 104, and an output voltage detector circuit 105. This self-excited switching power supply device is configured as follows. An induced voltage Vd appearing at one end of a tertiary feedback winding Nd is used for providing positive feedback to the gate of the oscillating transistor 102, thereby making the oscillating transistor 102 turn on/off by itself without depending on an external pulse, and the energy accumulated in the transformer 101 during the on period of the oscillating transistor 102 is released to the output side during the off period thereof.

As shown in FIG. 6, many self-excited switching power supply devices configured as described above are so configured as to stabilize an output voltage Vo by changing the switching frequency or on-duty of the oscillating transistor 102 according to the detection result of the output voltage Vo.

Incidentally, the RCC-type self-excited switching power supply device in general has the following properties. As the load becomes lighter and hence the output electric power becomes lower, the switching frequency of the oscillating transistor 102 increases to a level higher than necessary, causing an increase in loss and hence a reduction in efficiency (see the dashed line L2 in FIG. 4).

Therefore, to prevent such a reduction in efficiency in light load conditions, there has conventionally been proposed an RCC-type self-excited switching power supply device, like one shown in FIG. 6, which has a function (a standby power-saving function) of changing the driving mode of the oscillating transistor 102 from successive oscillation to intermittent oscillation according to the monitoring result obtained by the oscillation control circuit 103 monitoring a control signal EX inputted from outside (e.g., a standby mode changing signal inputted from a microcomputer when an appliance is in standby).

As a conventional technology related to what has been described thus far, a self-excited switching power supply circuit has been disclosed and proposed in JP-A-2002-051546 (hereinafter “Patent Document 1”). Even in light load conditions, when detecting an output current that is passed through the output line by the load, this self-excited switching power supply circuit judges that it is in the operating state, causing self-excited oscillation to be continuously performed. On the other hand, when detecting no output current passing through the output line, the self-excited switching power supply circuit judges that it is in the standby state, comparing the output detecting voltage with a reference voltage and then inputting a delayed output detecting voltage to an output voltage detector circuit that controls an output voltage to be constant, so as to change the operation thereof from successive oscillation to intermittent oscillation.

As another conventional technology related to what has been described thus far, an intermittent oscillation circuit and an oscillation circuit have been disclosed and proposed in JP-A-2001-274658 (hereinafter “Patent Document 2”). The intermittent oscillation circuit proposed in this document is provided with: a capacitor that is charged by a current fed from a current source; switching means that makes the capacitor release the electric charge accumulated therein to an output terminal when it is turned on; and control means that turns on the switching means when a charging voltage of the capacitor becomes a first voltage, and turns off the switching means when the charging voltage of the capacitor becomes a second voltage that is lower than the first voltage.

Certainly, with the RCC-type self-excited switching power supply device shown in FIG. 6, it is possible to effectively reduce electric power consumption in light load conditions.

However, the RCC-type self-excited switching power supply device shown in FIG. 6 requires an input of an external control signal EX to perform switching between successive oscillation and intermittent oscillation. This makes it inapplicable to applications that cannot receive an input of such an external control signal.

Incidentally, in the conventional technology disclosed in Patent Document 1, switching between successive oscillation and intermittent oscillation is performed by detecting whether or not an output current greater than a predetermined value is flowing. As a result, the driving mode is not switched from intermittent oscillation to successive oscillation until an output current greater than a predetermined value flows. This may results in a higher output ripple voltage.

Furthermore, the conventional technology disclosed in Patent Document 2 adopts an intermittent oscillation method and a switching method that are different from those of the present invention, and is therefore fundamentally different in configuration from that of the present invention.

### SUMMARY OF THE INVENTION

In view of the conventionally experienced problems described above, an object of the present invention is to provide power supply devices that can achieve an improvement in efficiency in light load conditions without increasing an output ripple voltage, and to provide electric appliances provided with such power supply devices.

To achieve the above object, according to one aspect of the present invention, a power supply device is provided with: a transformer that is provided with a primary input winding, a secondary output winding, and a tertiary feedback winding; an oscillating transistor that is serially connected to the primary input winding; a first circuit that turns on the oscillating transistor by using an input voltage and an induced voltage in the tertiary feedback winding; an oscillation control transistor that turns on so as to turn off the oscillating transistor; a second circuit that turns on/off the oscillation control transistor by using the induced voltage in the tertiary feedback winding; an output smoother circuit that produces an output voltage by smoothing an induced voltage appearing across the secondary output winding; an output detector circuit that detects whether or not the output voltage has reached a given threshold; and a third circuit that, when the output voltage has reached the given threshold during the off period of the oscillation control transistor, advances the timing with which the oscillation control transistor turns on by using the induced voltage in the tertiary feedback winding, and that, when the output voltage has reached the given threshold during the on period of the oscillation control transistor, delays the timing with which the oscillation control transistor turns off until a predetermined period during which the oscillation control transistor is forcibly kept on has elapsed, or, before this, until the output voltage has dropped below the given threshold.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a circuit diagram showing a first embodiment of a self-excited switching power supply device according to the invention;

FIG. 2 is a voltage waveform diagram showing an example of how a voltage Vp appearing at the other end of a primary input winding Np and an induced voltage Vd in a tertiary feedback winding Nd behave;

FIG. 3 is a voltage waveform diagram explaining intermittent oscillation of the self-excited switching power supply device of this embodiment;

FIG. 4 is a diagram showing an improvement in efficiency in light load conditions;

FIG. 5 is a circuit diagram showing a second embodiment of a self-excited switching power supply device according to the invention; and

FIG. 6 is a block diagram showing an example of a conventional self-excited switching power supply device.

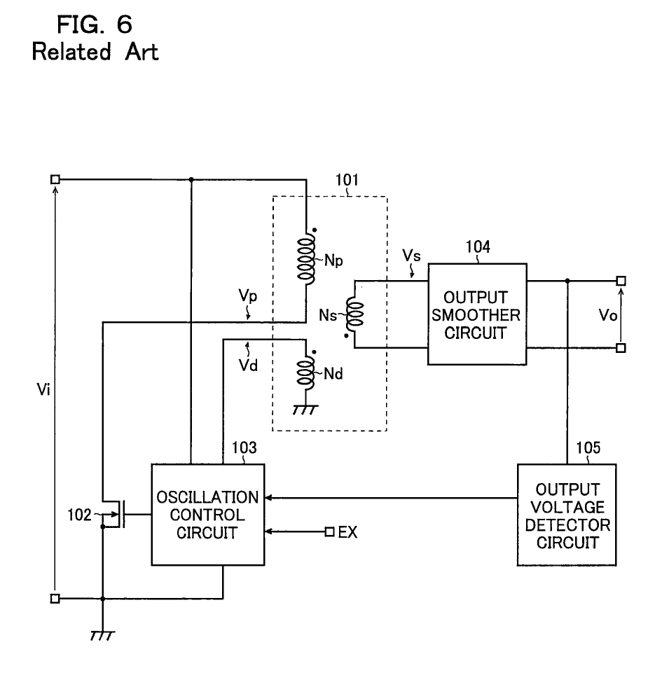

### DETAILED DESCRIPTION OF PREFERRED EMBODIMENTS

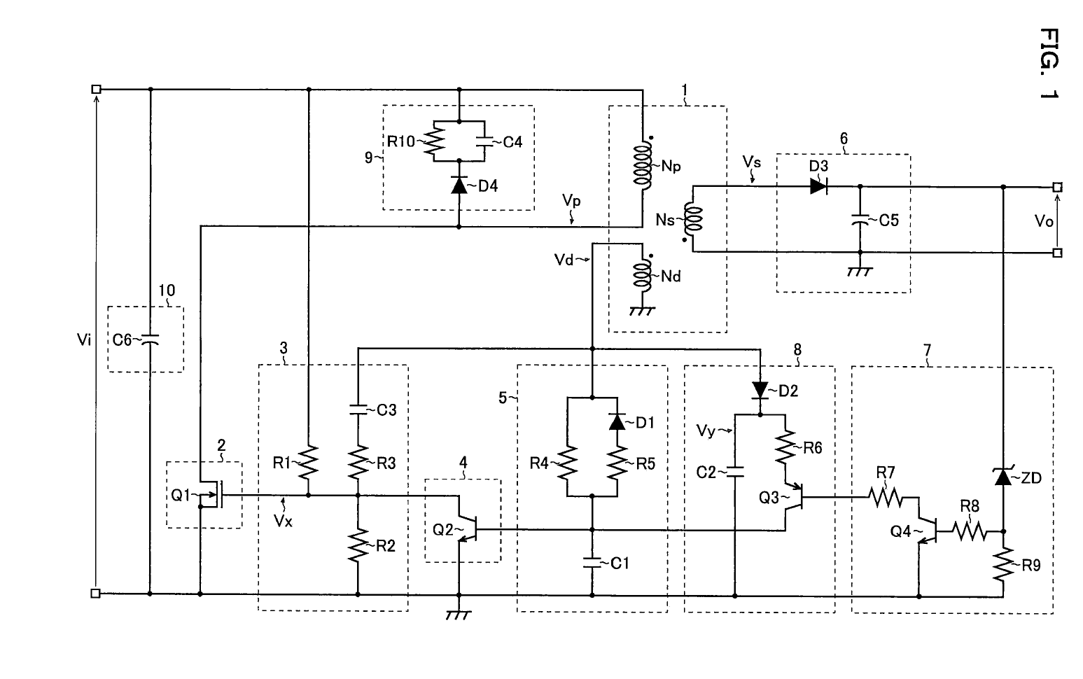

FIG. 1 is a circuit diagram showing a first embodiment of a self-excited switching power supply device according to the invention.

As shown in this figure, the power supply device of this embodiment includes a transformer 1, an oscillating transistor 2, a first circuit 3, an oscillation control transistor 4, a second circuit 5, an output smoother circuit 6, an output detector circuit 7, a third circuit 8, a snubber circuit 9, and an input smoother circuit 10.

The transformer 1 is composed of: a primary input winding Np (number of turns: np) that is connected, at one end thereof, to a point to which an input voltage Vi is applied; a secondary output winding Ns (number of turns: ns) in which a voltage (an induced voltage Vs) opposite in phase to that across the primary input winding Np is induced; and a tertiary feedback winding Nd (number of turns: nd) in which a voltage (an induced voltage Vd) in phase with that across the primary input winding Np is induced.

The oscillating transistor 2 is an N-channel field-effect transistor Q1 connected between the other end of the primary input winding Np and a ground.

The first circuit 3 is composed of resistors R1 to R3 and a capacitor C3. The resistor R1 is connected between the point to which the input voltage Vi is applied and the gate of the transistor Q1. The resistor R2 is connected between the gate of the transistor Q1 and the ground. The resistor R3 and the capacitor C3 are connected in series between the gate of the transistor Q1 and one end of the tertiary feedback winding Nd (an induced voltage Vd output node).

The oscillation control transistor 4 is an npn bipolar transistor Q2 connected between the gate of the transistor Q1 and the ground.

The second circuit 5 is composed of resistors R4 and R5, a capacitor C1, and a diode D1. One end of the resistor R4 and the cathode of the diode D1 are both connected to the one end of the tertiary feedback winding Nd. The anode of the diode D1 is connected to one end of the resistor R5. The other ends of the resistors R4 and R5 are both connected to the base of the transistor Q2. The capacitor C1 is connected between the base of the transistor Q2 and the ground.

The output smoother circuit 6 is composed of a diode D3 and a capacitor C5. The anode of the diode D3 is connected to one end of the secondary output winding Ns; the cathode thereof is connected to one end of the capacitor C5. The other end of the capacitor C5 is connected to the other end of the secondary output winding Ns and to the ground. A voltage across the capacitor C5 is outputted as an output voltage Vo.

The output detector circuit 7 is composed of resistors R7 to R9, an npn bipolar transistor Q4, and a Zener diode ZD. The cathode of the Zener diode ZD is connected to the one end (high-potential end) of the capacitor C5. The anode of the Zener diode ZD is connected to the base of the transistor Q4 via the resistor R8, and to the ground via the resistor R9. The collector of the transistor Q4 is connected, via the resistor R7, to a node (the base of a transistor Q3, which will be described later) to which a signal of the third circuit 8 is inputted. The emitter of the transistor Q4 is connected to the ground.

The third circuit 8 is composed of a resistor R6, a diode D2, a pnp bipolar transistor Q3, and a capacitor C2. The anode of the diode D2 is connected to the one end of the tertiary feedback winding Nd. The cathode of the diode D2 is connected to the emitter of the transistor Q3 via the resistor R6, and to the ground via the capacitor C2. The collector of the transistor Q3 is connected to the base of the transistor Q2.

The snubber circuit 9 is composed of a resistor R10, a diode D4, and a capacitor C4. The resistor R10 and the capacitor C4 are connected, at their respective one ends, to the one end of the primary input winding Np. The other ends of the resistor R10 and the capacitor C4 are both connected to the cathode of the diode D4. The anode of the diode D4 is connected to the other end of the primary input winding Np.

The input smoother circuit 10 is composed of a capacitor C6 connected between the point to which the input voltage Vi is applied and the ground.

Hereinafter, how the self-excited switching power supply device configured as described above operates will be specifically described.

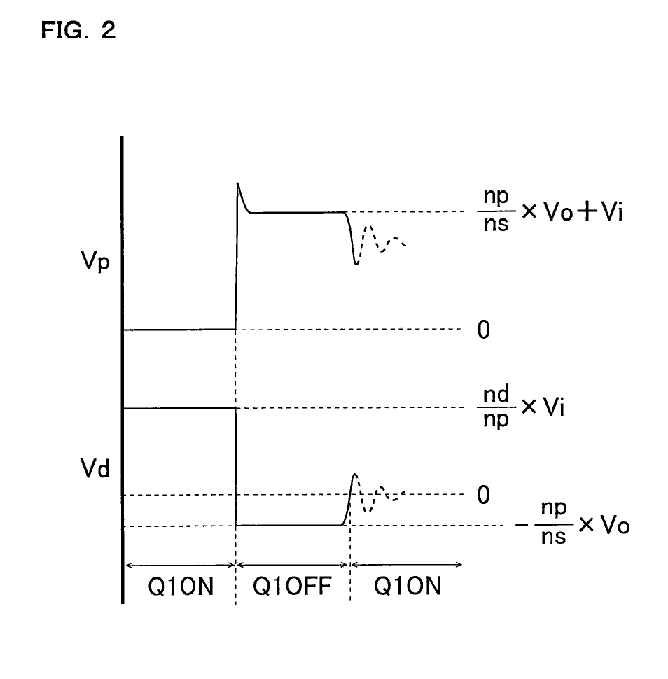

First, the principle of successive oscillation will be specifically described with reference to FIG. 2 in addition to the above-mentioned FIG. 1.

FIG. 2 is a voltage waveform diagram showing an example of how a voltage Vp appearing at the other end of the primary input winding Np and an induced voltage Vd in the tertiary feedback winding Nd behave.

When the input voltage Vi is applied, a gate voltage Vx of the transistor Q1 through the resistor R1 starts increasing. When the gate voltage Vx of the transistor Q1 has reached a turn-on threshold voltage Vth, the transistor Q1 turns on.

When the transistor Q1 turns on, the voltage Vp appearing at the other end of the primary input winding Np becomes equal to the ground potential, so that a current flows through the primary input winding Np and a given potential difference (almost equal to the input voltage Vi) is produced across it. When such a given potential difference (Vi) is produced across the primary input winding Np, an induced voltage Vd (=nd/np=Vi) commensurate with the turns ratio (nd/np) of the tertiary feedback winding Nd to the primary input winding Np is induced in the tertiary feedback winding Nd. As a result, the gate of the transistor Q1 is fed with the electric charge not only through a path along which the resistor R1 is present but also through a path along which the capacitor C3 and the resistor R3 are present. This helps increase the gate voltage Vx of the transistor Q1 more quickly than when the transistor Q1 is fed with the electric charge only through the resistor R1, permitting the transistor Q1 to make a quick transition to a stable state.

Incidentally, when a positive induced voltage Vd is induced in the tertiary feedback winding Nd, electric charge is accumulated in the capacitor C1 through the resistor R4, causing an increase in a terminal voltage (charging voltage) of the capacitor C1. When a voltage between the emitter and the base of the transistor Q2 has reached a turn-on threshold voltage, the transistor Q2 turns on, making the gate voltage Vx of the transistor Q1 drop to the ground potential. In this way, when the transistor Q2 turns on, the transistor Q1 is turned off.

At this point, if the output voltage Vo has not reached a given threshold, and thus the Zener diode ZD is not turned on, the transistor Q4 and the transistor Q3 are both off. As a result the capacitor C1 is charged only through a path along which the resistor R4 is present. Thus, the voltage rising speed (charging speed) of the capacitor C1 is determined simply by the time constant of the resistor R4 and the capacitor C1.

On the other hand, if the output voltage Vo has reached the given threshold, and thus the Zener diode ZD is turned on, the transistor Q4 and the transistor Q3 are both on. As a result, the capacitor C1 is fed with the electric charge not only through a path along which the resistor R4 is present but also through a path along which the diode D2, the resistor R6, and the transistor Q3 are present.

Therefore, by setting the resistance of the resistor R6 to a value (a several hundreds of ohms (Ω)) smaller than the resistance (several kilohms (kΩ)) of the resistor R4, as compared with when the Zener diode ZD is off, when the Zener diode ZD is on, it is possible to advance the timing with which the transistor Q2 turns on. That is, when the output voltage Vo has reached the given threshold, it is possible to make the output voltage Vo equal to a desired value by making shorter the energy charge period of the transformer 1.

When the transistor Q1 is turned off as a result of the transistor Q2 turning on, a back electromotive force is produced across the primary input winding Np. This causes all the polarities to be inverted; the induced voltage Vs in the secondary output winding Ns is inverted from the negative potential (−ns/np×Vi) to a positive potential. This brings the diode D3 into conduction, causing the electric charge to be accumulated in the capacitor C5. As a result, the output voltage Vo is produced.

At this point, the induced voltage Vd in the tertiary feedback winding Nd is inverted from the positive potential (nd/np×Vi) to a negative potential (−nd/ns×Vo). As a result of this polarity inversion, the diode D1 is brought into conduction, so that the electric charge of the capacitor C1 is discharged not only through a path along which the resistor R4 is present but also through a path along which the resistor R5 and the diode D1 are present. Thus, if the output voltage Vo has not reached the given threshold, and thus the Zener diode ZD is turned off, the transistor Q2 turns off as soon as the capacitor C1 is discharged.

As described above, the second circuit 5 of this embodiment is provided, as a charging/discharging circuit for the capacitor C1, not only with a charging/discharging path (the resistor R4) used for charging and discharging of the capacitor C1 but also with a discharging-only path (the resistor R5 and the diode D1) used only for discharging of the capacitor C1. With this configuration, by appropriately adjusting the resistances of the resistors R4 and R5 with consideration given to both the positive induced voltage Vd (=nd/np×Vi) at the time of charging of the capacitor C1 and the negative induced voltage Vd (=−nd/ns×Vo) at the time of discharging thereof, it is possible to give the charging/discharging waveform of the capacitor C1 a desired shape.

When the output voltage Vo is produced across the secondary output winding Ns, the voltage Vp appearing at the other end of the primary winding Np increases from the ground potential to a positive potential (np/ns×Vo+Vi). At the time of such polarity inversion, due to the leakage inductance of the primary winding Np, a voltage spike is generated in the voltage Vp appearing at the other end of the primary winding Np. This voltage spike is suppressed to a voltage level that does not affect the circuitry (a voltage level not exceeding the withstand voltage of the transistor Q1) by the snubber circuit 9 provided between the two ends of the primary input winding Np.

After the polarity inversion described above, when all the energy that has been accumulated in the transformer 1 during the on period of the transistor Q1 is conveyed to the secondary output winding Ns, that is, when the secondary output winding Ns passes all the current through the diode D3, ringing occurs in the voltage Vp appearing at the other end of the primary input winding Np due to a parasitic inductance component of the primary input winding Np and a parasitic capacitance component between the source and the drain of the transistor Q1. Such ringing induces in-phase ringing in the induced voltage Vd in the tertiary feedback winding Nd.

At this point, the induced voltage Vd in the tertiary feedback winding Nd temporarily rises from the negative potential to a positive potential. This causes an increase in the gate voltage Vx of the transistor Q1 via the capacitor C3 and the resistor R3, turning on the transistor Q1 again. Thereafter, the above-described operation is repeated. In this way, successive oscillation is performed in the self-excited switching power supply device of this embodiment.

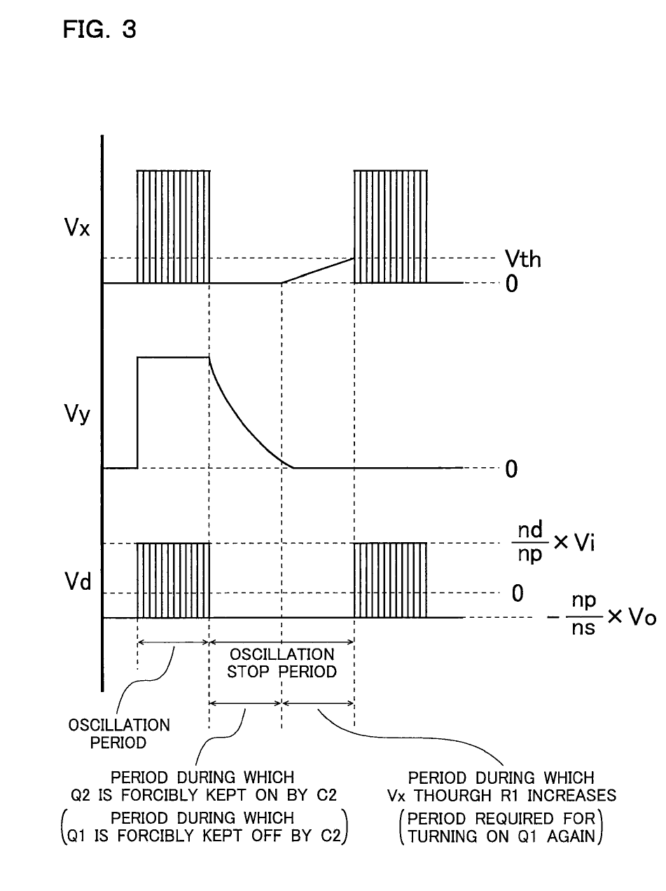

Next, the principle of intermittent oscillation will be specifically described with reference to FIG. 3 in addition to the above-mentioned FIG. 1.

FIG. 3 is a voltage waveform diagram explaining intermittent oscillation of the self-excited switching power supply device of this embodiment.

As mentioned earlier, when the transistor Q1 is turned on and a potential difference Vi is thus produced across the primary input winding Np, a positive induced voltage Vd is induced in the tertiary feedback winding Nd. At this point, electric charge is accumulated in the capacitor C2 through the diode D2, whereby a positive terminal voltage Vy is produced.

If no capacitor C2 is provided, the induced voltage Vd in the tertiary feedback winding Nd is at a negative potential during the off period of the transistor Q1. Thus, even when the Zener diode ZD has been on for long periods of time (for example, in light load conditions), the transistor Q3 is unable to operate, causing the capacitor C1 to be promptly discharged and the transistor Q2 to turn off. This results in undesirable continuation of the above-described successive oscillation, causing a reduction in efficiency in light load conditions.

By contrast, with the self-excited switching power supply device of this embodiment, even when the transistor Q1 is off (the induced voltage Vd is at a negative potential), it is possible to keep the transistor Q3 operable by using the terminal voltage Vy of the capacitor C2. Thus, even when the transistor Q1 is off, the transistor Q4 and the transistor Q3 are turned on if the Zener diode ZD is on. This makes it possible to feed the electric charge from the capacitor C2 to the capacitor C1 through the resistor R6 and the transistor Q3.

That is, while the capacitor C1 is discharged of electric charge through a charging/discharging circuit (the resistors R4 and R5 and the diode D1) that forms the second circuit 5, it is additionally fed with the electric charge from the capacitor C2 through the transistor Q3. As a result, the timing with which the transistor Q2 turns off is delayed by the amount of electric charge that has been additionally fed.

In this way, if the Zener diode ZD is on during the off period of the transistor Q1 (the on period of the transistor Q2), the transistor Q2 is forcibly kept on by additionally feeding the electric charge to the capacitor C1 from the capacitor C2. In this state, since the gate voltage Vx of the transistor Q1 is at the ground potential, even when ringing occurs in the induced voltage Vd in the tertiary feedback winding Nd as a result of the secondary output winding Ns passing all the current through the diode D3, the transistor Q1 is not turned on.

Incidentally, ringing in the induced voltage Vd is attenuated as time passes. After the amplitude thereof is attenuated below the turn-on threshold voltage of the transistor Q1, the transistor Q2 turns off. Thus, even when ringing causes an increase in the gate voltage Vx of the transistor Q1, the transistor Q1 is not turned on.

As mentioned earlier, during the off period of the transistor Q1, since the induced voltage Vd in the tertiary feedback winding Nd is at a negative potential, no electric charge is fed to the capacitor C2. As a result, the terminal voltage Vy of the capacitor C2 keeps getting lower and lower.

Thus, by providing the capacitor C2, the timing with which the transistor Q2 turns off is delayed until the transistor Q3 cannot be kept on as a result of the capacitor C2 having been discharged, or, before this, until the transistor Q3 is turned off as a result of the output voltage Vo having dropped below the given threshold.

As described above, by delaying the timing with which the transistor Q2 turns off, once successive oscillation is stopped, the device stops oscillation until, as in the case of the start of the driving of the power supply device, the gate voltage Vx of the transistor Q1 through the resistor R1 has increased to the turn-on threshold voltage Vth after a period during which the transistor Q2 is forcibly kept on by the capacitor C2 (during which the transistor Q1 is forcibly kept off) has elapsed.

That is, the device stops oscillation for a period equal to the sum of the length of the period during which the transistor Q2 is forcibly kept on by the capacitor C2 (the period during which the transistor Q1 is forcibly kept off and the length of the period required for turning on the transistor Q1 again by way of the resistor R1.

As described above, with the self-excited switching power supply device of this embodiment, it is possible to automatically change the driving mode of the transistor Q1 from successive oscillation to intermittent oscillation according to the detection result of the output voltage Vo. This helps effectively reduce the electric power consumption in light load conditions.

Additionally, with the self-excited switching power supply device of this embodiment, even when the Zener diode ZD is kept on during the off period of the transistor Q1 (the on period of the transistor Q2), the transistor Q3 is turned off when the electric charge accumulated in the capacitor C2 is discharged. This causes the transistor Q2 to turn off without waiting for the Zener diode ZD to turn off as a result of the output voltage Vo having dropped below the given threshold.

That is, with the self-excited switching power supply device of this embodiment, by appropriately adjust the capacitance of the capacitor C2, it is possible to return the driving mode of the transistor Q1 from the intermittent oscillation to the successive oscillation with any given timing.

Thus, the self-excited switching power supply device of this embodiment offers the following advantages. The driving mode of the transistor Q1 is automatically changed from the successive oscillation to the intermittent oscillation, so that an improvement in efficiency in light load conditions is achieved. In addition to this, the driving mode of the transistor Q1 is returned to the successive oscillation with any given timing, so that an increase in an output ripple voltage can be prevented.

Even when the capacitor C2 has been charged, the operation is not changed to the intermittent oscillation if the Zener diode ZD is off during the off period of the transistor Q1 (the on period of the transistor Q2), so that the successive oscillation is continuously performed. Furthermore, even when the Zener diode ZD is on during the off period of the transistor Q1 (the on period of the transistor Q2), and the transistor Q2 is temporarily kept on by using the terminal voltage Vy of the capacitor C2, the successive oscillation is continuously performed if the Zener diode ZD is turned off or the electric charge accumulated in the capacitor C2 is discharged before ringing occurs in the induced voltage Vd in the tertiary feedback winding Nd or before such ringing has been completely attenuated.

As described above, the self-excited switching power supply device according to the invention includes: the transformer 1 provided with the primary input winding Np, the secondary output winding Ns, and the tertiary feedback winding Nd; the oscillating transistor 2 serially connected to the primary input winding Np; the first circuit 3 that turns on the oscillating transistor 2 by using the input voltage Vi and the induced voltage Vd in the tertiary feedback winding Nd; the oscillation control transistor 4 that turns on so as to turn off the oscillating transistor 2; the second circuit 5 that turns on/off the oscillation control transistor 2 by using the induced voltage Vd in the tertiary feedback winding Nd; the output smoother circuit 6 that produces the output voltage Vo by smoothing the induced voltage Vs appearing across the secondary output winding Ns; the output detector circuit 7 that detects whether or not the output voltage Vo has reached the given threshold; and the third circuit 8 that, when the output voltage Vo has reached the given threshold during the off period of the oscillation control transistor 4, advances the timing with which the oscillation control transistor 4 turns on by using the induced voltage Vd in the tertiary feedback winding Nd, and that, when the output voltage Vo has reached the given threshold during the on period of the oscillation control transistor 4, delays the timing with which the oscillation control transistor 4 turns off until a predetermined period during which the oscillation control transistor 4 is forcibly kept on has elapsed, or, before this, until the output voltage Vo has dropped below the given threshold.

More specifically, the self-excited switching power supply device according to the invention includes: the transformer 1 provided with the primary input winding Np connected, at one end thereof, to a point to which the input voltage Vi is applied, the secondary output winding Ns in which a voltage opposite in phase to that across the primary input winding Np is induced, and the tertiary feedback winding Nd in which a voltage in phase with that across the primary input winding Np is induced; the oscillating transistor 2 that is the N-channel field-effect transistor Q1 connected between the other end of the primary input winding Np and the ground; the first circuit 3 that is provided with a resistor R1 connected between the point to which the input voltage Vi is applied and the gate of the transistor Q1 and a positive feedback circuit (the resistor R3 and the capacitor C3) connected between one end of the tertiary feedback winding Nd and the gate of the transistor Q1, and that turns on the transistor Q1 by using the input voltage Vi and the induced voltage Vd appearing at the one end of the tertiary feedback winding Nd; the oscillation control transistor 4 that is the npn bipolar transistor Q2 connected between the gate of the transistor Q1 and the ground, and that turns on so as to turn off the transistor Q1; the second circuit 5 that is provided with a first capacitor C1 connected between the base of the transistor Q2 and the ground and a charging/discharging circuit (e.g., the resistor R4) connected between the one end of the tertiary feedback winding Nd and the base of the transistor Q2, and that turns on/off the transistor Q2 by using the induced voltage Vd in the tertiary feedback winding Nd; the output smoother circuit 6 that produces the output voltage Vo by smoothing the induced voltage Vs appearing across the secondary output winding Ns; the output detector circuit 7 that detects whether or not the output voltage Vo has reached the given threshold; and the third circuit 8 that is provided with the diode D2 whose anode is connected to the one end of the tertiary feedback winding Nd, a bypass switch (in the first embodiment, the transistor Q3) that is connected between the cathode of the diode D2 and the base of the transistor Q2, and that is turned on/off according to the detection result of the output detector circuit 7, and a second capacitor C2 connected between the cathode of the diode D2 and the ground, and that, when the output voltage Vo has reached the given threshold during the off period of the transistor Q2, turns on the bypass switch and thereby advances the timing with which the transistor Q2 turns on by using the induced voltage Vd in the tertiary feedback winding Nd, and that, when the output voltage Vo has reached the given threshold during the on period of the transistor Q2, keeps the on state of the bypass switch by using the electric charge accumulated in the second capacitor C2 and thereby delays the timing with which the transistor Q2 turns off until the bypass switch is turned off as a result of the second capacitor C2 having been discharged, or, before this, until the bypass switch is turned off as a result of the output voltage Vo having dropped below the given threshold.

With this configuration, it is possible to achieve an improvement in efficiency in light load conditions without increasing an output ripple voltage.

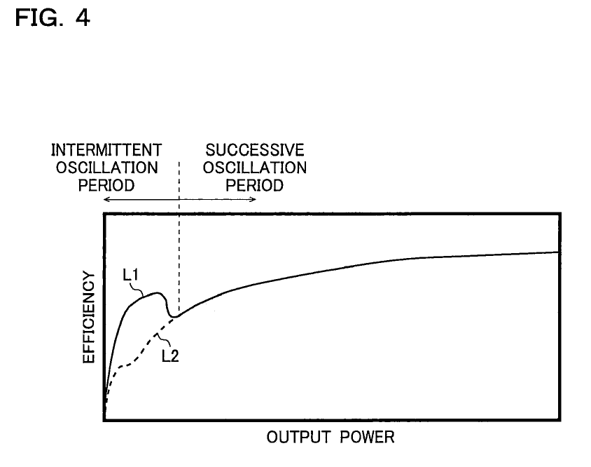

FIG. 4 is a diagram showing an improvement in efficiency in light load conditions (a diagram showing the correlation between the output power and efficiency). In this figure, the solid line L1 represents the efficiency of a self-excited switching power supply device to which the invention is applied, and the dashed line L2 represents, for reference purposes, the efficiency of a self-excited switching power supply device having a conventional configuration (in which successive oscillation is continuously performed). As shown in this figure, the self-excited switching power supply device of this embodiment, as compared with the conventional one, can greatly improve the efficiency in light load conditions (in other words, the efficiency in an output power period during which intermittent oscillation is performed).

The invention may be practiced in any other manner than specifically described above, with any modification or variation made within the spirit of the invention.

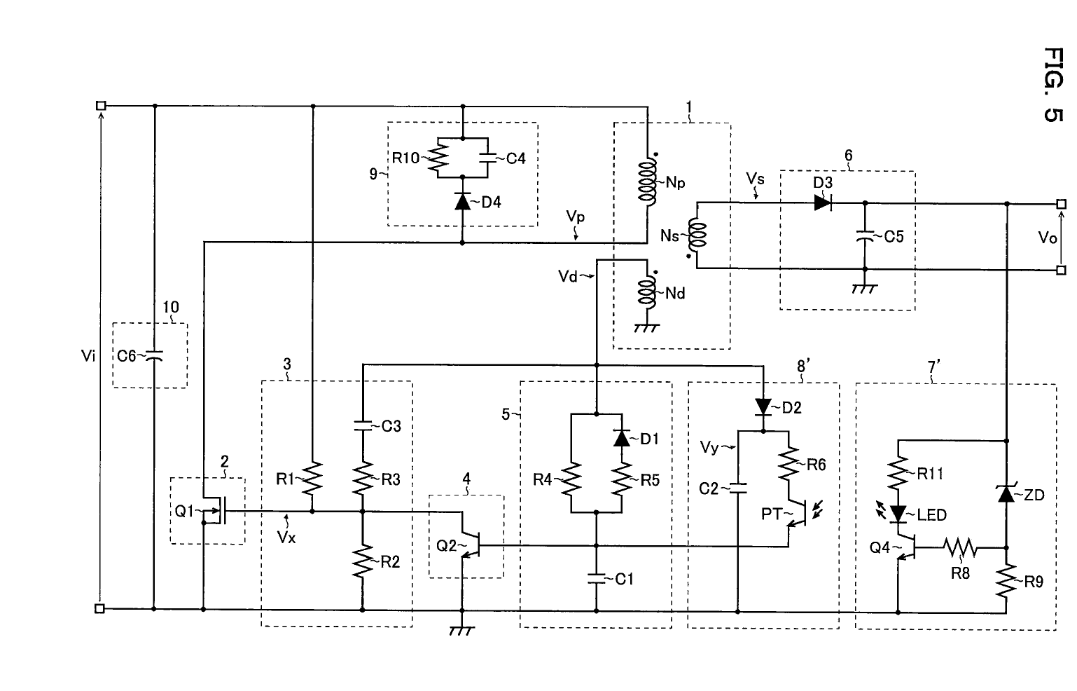

For example, the embodiment described above deals with a configuration in which no electrical isolation is provided between the output detector circuit 7 and the third circuit 8. However, the present invention is not limited to this specific configuration, but may be so implemented that, as shown in FIG. 5, electrical isolation is provided between an output detector circuit 7′ and a third circuit 8′ by using a photocoupler.

Incidentally, in the self-excited switching power supply device shown in FIG. 5, the output detector circuit 7′ includes a photocoupler light-emitting element (a light-emitting diode LED) that is turned on/off according to whether or not the output voltage Vo has reached the given threshold, and the third circuit 8′ includes, as the bypass switch, instead of the transistor Q3 described above, a photocoupler light-receiving element (a phototransistor PT) that is turned on/off according to an optical signal from the light-emitting diode LED.

With this configuration, it is possible to provide electrical isolation between the primary winding and the secondary winding of the transformer 1. This helps enhance the safety of a power supply device incorporated in home appliances such as washing machines and IH cooking heaters used in a wet area in a home.

The embodiment described above deals with a configuration in which the output voltage Vo is detected according to the on/off of the Zener diode ZD. However, the present invention is not limited to this specific configuration, but may be so implemented that, in a case where higher-accuracy detection is required, a comparator is provided that compares the output voltage Vo (or a voltage obtained by dividing the output voltage Vo) with a given threshold voltage, and the comparison result is outputted to the third circuit 8.

The invention offers the following advantages: it helps realize power supply devices that can achieve an improvement in efficiency in light load conditions without increasing an output ripple voltage; hence, it helps realize electric appliances provided with such power supply devices.

In terms of industrial applicability, the invention finds wide application in power supply devices incorporated in various types of electric appliances such as home appliances including washing machines and IH cooking heaters, battery chargers, and AC adopters.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A power supply device comprising:
a transformer that is provided with a primary input winding, a secondary output winding, and a tertiary feedback winding;
an oscillating transistor that is serially connected to the primary input winding;
a first circuit that turns on the oscillating transistor by using an input voltage and an induced voltage in the tertiary feedback winding;
an oscillation control transistor that turns on so as to turn off the oscillating transistor;
a second circuit that turns on/off the oscillation control transistor by using the induced voltage in the tertiary feedback winding;
an output smoother circuit that produces an output voltage by smoothing an induced voltage appearing across the secondary output winding;
an output detector circuit that detects whether or not the output voltage has reached a given threshold; and
a third circuit that, when the output voltage has reached the given threshold during an off period of the oscillation control transistor, advances a timing with which the oscillation control transistor turns on by using the induced voltage in the tertiary feedback winding, and that, when the output voltage has reached the given threshold during an on period of the oscillation control transistor, delays a timing with which the oscillation control transistor turns off until a predetermined period during which the oscillation control transistor is forcibly kept on has elapsed, or, before this, until the output voltage has dropped below the given threshold.

2. A power supply device comprising:
a transformer provided with a primary input winding that is connected, at one end thereof, to a point to which an input voltage is applied, a secondary output winding in which a voltage opposite in phase to a voltage across the primary input winding is induced, and a tertiary feedback winding in which a voltage in phase with the voltage across the primary input winding is induced;
an oscillating transistor that is an N-channel field-effect transistor connected between the other end of the primary input winding and a ground;
a first circuit that is provided with a resistor connected between the point to which the input voltage is applied and a gate of the oscillating transistor and a positive feedback circuit connected between one end of the tertiary feedback winding and the gate of the oscillating transistor, and that turns on the oscillating transistor by using the input voltage and an induced voltage appearing at the one end of the tertiary feedback winding;
an oscillation control transistor that is an npn bipolar transistor connected between the gate of the oscillating transistor and the ground, and that turns on so as to turn off the oscillating transistor;
a second circuit that is provided with a first capacitor connected between a base of the oscillation control transistor and the ground and a charging/discharging circuit connected between the one end of the tertiary feedback winding and the base of the oscillation control transistor, and that turns on/off the oscillation control transistor by using the induced voltage in the tertiary feedback winding;
an output smoother circuit that produces an output voltage by smoothing an induced voltage appearing across the secondary output winding; an output detector circuit that detects whether or not the output voltage has reached a given threshold; and
a third circuit
that is provided with a diode whose anode is connected to the one end of the tertiary feedback winding, a bypass switch that is connected between a cathode of the diode and the base of the oscillation control transistor, and that is turned on/off according to a detection result of the output detector circuit, and a second capacitor connected between the cathode of the diode and the ground,
when the output voltage has reached the given threshold during an off period of the oscillation control transistor, that turns on the bypass switch and thereby advances a timing with which the oscillation control transistor turns on by using the induced voltage in the tertiary feedback winding, and
when the output voltage has reached the given threshold during an on period of the oscillation control transistor, that keeps an on state of the bypass switch by using an electric charge accumulated in the second capacitor and thereby delays a timing with which the oscillation control transistor turns off until the bypass switch cannot be kept on as a result of the second capacitor having been discharged, or, before this, until the bypass switch is turned off as a result of the output voltage having dropped below the given threshold.

3. The power supply device of claim 2, wherein
the charging/discharging circuit includes:
a charging/discharging path that is used for charging and discharging of the first capacitor; and
a discharging-only path that is used only for discharging of the first capacitor.

4. The power supply device of claim 2, further comprising:
a snubber circuit that is connected between two ends of the primary input winding.

5. The power supply device of claim 2,
wherein the output detector circuit includes:
a photocoupler light-emitting element that is turned on/off according to whether or not the output voltage has reached the given threshold,
wherein the third circuit includes:
as the bypass switch, a photocoupler light-receiving element that is turned on/off according to an optical signal from the photocoupler light-emitting element.

6. An electric appliance comprising:
a power supply device that is a power supply of the electric appliance,
wherein the power supply device includes:
a transformer that is provided with a primary input winding, a secondary output winding, and a tertiary feedback winding;
an oscillating transistor that is serially connected to the primary input winding;
a first circuit that turns on the oscillating transistor by using an input voltage and an induced voltage in the tertiary feedback winding;
an oscillation control transistor that turns on so as to turn off the oscillating transistor;
a second circuit that turns on/off the oscillation control transistor by using the induced voltage in the tertiary feedback winding;
an output smoother circuit that produces an output voltage by smoothing an induced voltage appearing across the secondary output winding;
an output detector circuit that detects whether or not the output voltage has reached a given threshold; and
a third circuit that, when the output voltage has reached the given threshold during an off period of the oscillation control transistor, advances a timing with which the oscillation control transistor turns on by using the induced voltage in the tertiary feedback winding, and that, when the output voltage has reached the given threshold during an on period of the oscillation control transistor, delays a timing with which the oscillation control transistor turns off until a predetermined period during which the oscillation control transistor is forcibly kept on has elapsed, or, before this, until the output voltage has dropped below the given threshold.

7. An electric appliance comprising:
a power supply device that is a power supply of the electric appliance,
wherein the power supply device includes:
a transformer provided with a primary input winding that is connected, at one end thereof, to a point to which an input voltage is applied, a secondary output winding in which a voltage opposite in phase to a voltage across the primary input winding is induced, and a tertiary feedback winding in which a voltage in phase with the voltage across the primary input winding is induced;
an oscillating transistor that is an N-channel field-effect transistor connected between the other end of the primary input winding and a ground;
a first circuit that is provided with a resistor connected between the point to which the input voltage is applied and a gate of the oscillating transistor and a positive feedback circuit connected between one end of the tertiary feedback winding and the gate of the oscillating transistor, and that turns on the oscillating transistor by using the input voltage and an induced voltage appearing at the one end of the tertiary feedback winding;
an oscillation control transistor that is an npn bipolar transistor connected between the gate of the oscillating transistor and the ground, and that turns on so as to turn off the oscillating transistor;
a second circuit that is provided with a first capacitor connected between a base of the oscillation control transistor and the ground and a charging/discharging circuit connected between the one end of the tertiary feedback winding and the base of the oscillation control transistor, and that turns on/off the oscillation control transistor by using the induced voltage in the tertiary feedback winding;
an output smoother circuit that produces an output voltage by smoothing an induced voltage appearing across the secondary output winding;
an output detector circuit that detects whether or not the output voltage has reached a given threshold; and
a third circuit
that is provided with a diode whose anode is connected to the one end of the tertiary feedback winding, a bypass switch that is connected between a cathode of the diode and the base of the oscillation control transistor, and that is turned on/off according to a detection result of the output detector circuit, and a second capacitor connected between the cathode of the diode and the ground,
when the output voltage has reached the given threshold during an off period of the oscillation control transistor, that turns on the bypass switch and thereby advances a timing with which the oscillation control transistor turns on by using the induced voltage in the tertiary feedback winding, and
when the output voltage has reached the given threshold during an on period of the oscillation control transistor, that keeps an on state of the bypass switch by using an electric charge accumulated in the second capacitor and thereby delays a timing with which the oscillation control transistor turns off until the bypass switch cannot be kept on as a result of the second capacitor having been discharged, or, before this, until the bypass switch is turned off as a result of the output voltage having dropped below the given threshold.

8. The electric appliance of claim 7, wherein
the charging/discharging circuit includes:
a charging/discharging path that is used for charging and discharging of the first capacitor; and
a discharging-only path that is used only for discharging of the first capacitor.

9. The electric appliance of claim 7, wherein
the power supply device further includes:
a snubber circuit that is connected between two ends of the primary input winding.

10. The electric appliance of claim 7,
wherein the output detector circuit includes:
a photocoupler light-emitting element that is turned on/off according to whether or not the output voltage has reached the given threshold,
wherein the third circuit includes:
as the bypass switch, a photocoupler light-receiving element that is turned on/off according to an optical signal from the photocoupler light-emitting element.
